(19) United States
(12) Patent Application Publication
(10) Pub. No.: US 2026/0217588 A1
(43) Pub. Date: Jul. 30, 2026

(54) COOLING AIR DEVICE FOR SUBSTRATE GLASS FORMING BY OVERFLOW PROCESS AND METHOD THEREOF

(71) Applicant: CAIHONG DISPLAY DEVICES CO., LTD., Xianyang (CN)

(72) Inventors: Weidong HU, Xianyang (CN); Yongjing REN, Xianyang (CN); Zhijun ZHANG, Xianyang (CN); Ting LUO, Xianyang (CN)

(73) Assignee: CAIHONG DISPLAY DEVICES CO., LTD., Xianyang (CN)

(21) Appl. No.: 19/437,330

(22) Filed: Dec. 31, 2025

Related U.S. Application Data
(63) Continuation-in-part of application No. PCT/CN2025/113525, filed on Aug. 8, 2025.

(30) Foreign Application Priority Data
Jan. 24, 2025 (CN) 202510119135.8

(51) Int. Cl. C03B 17/06

(52) U.S. Cl. CPC C03B 17/067; C03B 17/064

(57) ABSTRACT

Provided is a cooling air device for substrate glass forming by an overflow process and a method thereof. The cooling air device for substrate glass forming by an overflow process includes two homogenization boxes disposed at a bottom of an overflow brick, and a cooling mechanism. The two homogenization boxes are respectively located at two sides of a substrate glass. The cooling mechanism includes a plurality of cooling units, which are respectively disposed on the two homogenization boxes, each of the plurality of cooling units includes a first cooling air tube, a second cooling air tube, and a fixing assembly. The first cooling air tube is disposed outside a corresponding homogenization box. The second cooling air tube is inserted into an interior of a corresponding homogenization box. The first cooling air tube and the second cooling air tube are in communication with each other through the fixing assembly.

### CROSS-REFERENCE TO RELATED APPLICATIONS

This application is a continuation-in-part of International Application No. PCT/CN2025/113525, filed on Aug. 8, 2025, which claims priority to Chinese Patent Application No. 202510119135.8, filed on Jan. 24, 2025, the entire contents of each of which are incorporated herein by reference.

### TECHNICAL FIELD

The present disclosure relates to the field of glass manufacturing technologies, and in particular to a cooling air device for substrate glass forming by an overflow process and a method thereof.

### BACKGROUND

In the development process of the flat panel display industry, an overflow down-draw process is an important process for producing substrate glass. Molten glass flows down from an overflow brick and sequentially passes through a thickness forming region, a stress control region, and a warpage adjustment region, so as to form substrate glass with a uniform thickness and smooth surface. The thickness forming region is critical. To ensure rapid cooling and forming of the substrate glass, homogenization boxes are provided with thickness air ducts. By adjusting a cooling flow rate in the thickness air ducts, heat exchange between cooling air and the substrate glass is performed to achieve thickness adjustment of the substrate glass.

With the development of display technologies toward high definition, thinner profile, and large size, requirements for controlling the thickness uniformity of the substrate glass have become increasingly stringent. In the related art, the thickness air ducts are prone to deformation after long-term use, making it difficult to accurately adjust a relative position between the cooling air and the substrate glass, thereby resulting in repeated thickness adjustments of the substrate glass, low efficiency, and poor accuracy.

Therefore, there is an urgent need for a cooling air device for substrate glass forming by an overflow process and a method thereof to improve the accuracy and efficiency of the thickness adjustment of the substrate glass.

### SUMMARY

One or more embodiments of the present disclosure provide a cooling air device for substrate glass forming by an overflow process. The cooling air device for substrate glass forming by an overflow process includes two homogenization boxes disposed at a bottom of an overflow brick, and a cooling mechanism. The two homogenization boxes are respectively located at two sides of a substrate glass. The cooling mechanism includes a plurality of cooling units, which are respectively disposed on the two homogenization boxes, each of the plurality of cooling units includes a first cooling air tube, a second cooling air tube, and a fixing assembly. The first cooling air tube is disposed outside a corresponding homogenization box, and an air inlet of the first cooling air tube is configured to be in communication with a cooling air generation mechanism. The second cooling air tube is inserted into an interior of a corresponding homogenization box, an air outlet of the second cooling air tube is disposed facing the substrate glass, and the second cooling air tube is made of a high-temperature-resistant material. The first cooling air tube and the second cooling air tube are in communication with each other through the fixing assembly.

One or more embodiments of the present disclosure provide a method for using the cooling air device for substrate glass forming by an overflow process. The method includes the following operations. For each of the plurality of cooling units, the first cooling air tube and the second cooling air tube of the cooling unit are communicated and fixed based on the fixing assembly of the cooling unit. Cooling air is blown into the first cooling air tube, and the cooling air is blown into the interior of the corresponding homogenization box of the cooling unit through the air outlet of the second cooling air tube, so that heat exchange is performed among the cooling air, the corresponding homogenization box, and the substrate glass to reduce a temperature at a corresponding position of the substrate glass to achieve thickness adjustment of the substrate glass.

### BRIEF DESCRIPTION OF THE DRAWINGS

The present disclosure will be further described by way of exemplary embodiments, which are described in detail with reference to the drawings. These embodiments are not limiting. In the embodiments, the same reference numerals denote the same structures, in which:

FIG. 1 is a schematic diagram illustrating an exemplary cross-section of a cooling air device for substrate glass forming by an overflow process according to some embodiments of the present disclosure;

FIG. 2 is a schematic diagram illustrating a cooling unit according to some embodiments of the present disclosure;

FIG. 3 is a flowchart illustrating an exemplary process for determining an air inlet parameter of a first cooling air tube of a cooling unit according to some embodiments of the present disclosure; and

FIG. 4 is a flowchart illustrating an exemplary process for determining a coordination command according to some embodiments of the present disclosure.

Reference numeral description: 100, cooling air device; 1, homogenization box; 2, cooling mechanism; 200, cooling unit; 21, first cooling air tube; 22, second cooling air tube; 23, fixing assembly; 231, fixing base; 232, mounting step; 233, fixing member; 234, mounting groove; 235, sealing member; 24, first beam; 25, second beam; 3, substrate glass.

### DETAILED DESCRIPTION

In order to more clearly describe the technical solutions of the embodiments of the present disclosure, brief introductions to the drawings used in the description of the embodiments are provided below. Obviously, the drawings in the following description are merely some examples or embodiments of the present disclosure. For those of ordinary skill in the art, the present disclosure can be applied to other similar scenarios based on these drawings without creative effort. Unless obviously obtained from the context or the context illustrates otherwise, the same numeral in the drawings refers to the same structure or operation.

It should be understood that the terms “system”, “device”, “unit” and/or “module” used herein are a method for distinguishing components, elements, parts, sections or assemblies of different levels. If other words can achieve the same purpose, the words can be replaced by other expressions.

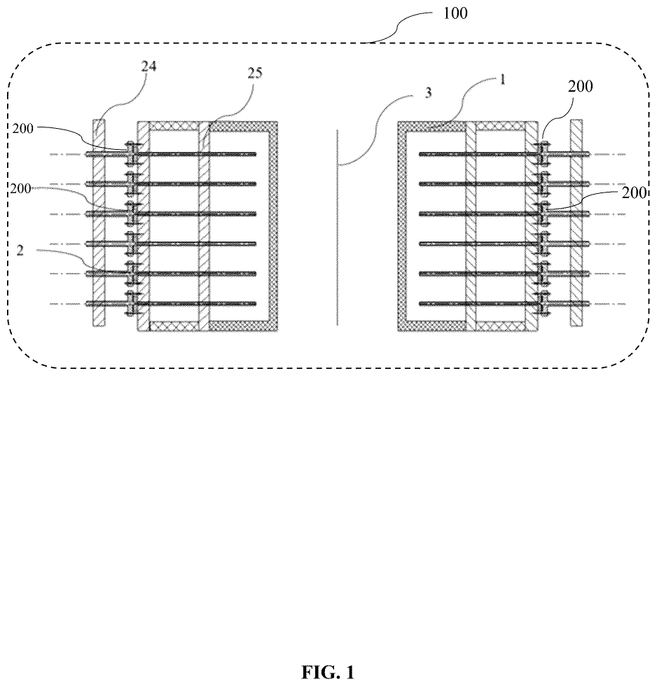

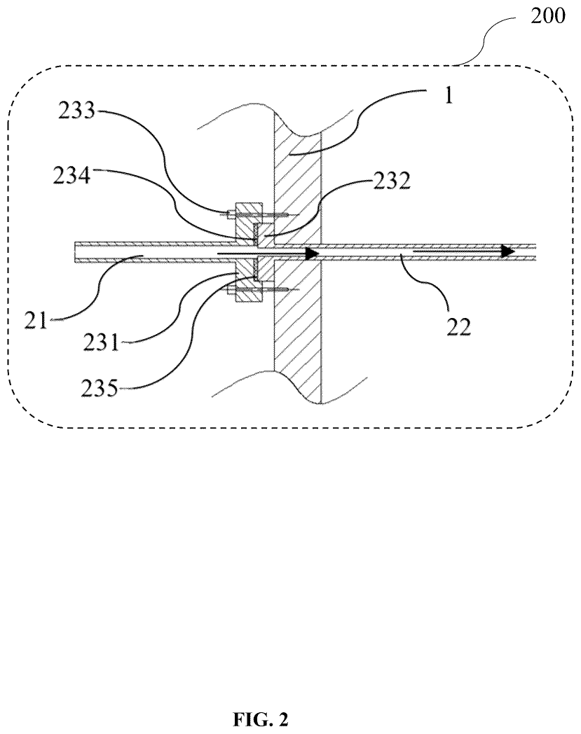

FIG. 1 is a schematic diagram illustrating an exemplary cross-section of a cooling air device for substrate glass forming by an overflow process according to some embodiments of the present disclosure. FIG. 2 is a schematic diagram illustrating a cooling unit according to some embodiments of the present disclosure. As shown in FIGS. 1 and 2, a cooling air device 100 may include two homogenization boxes 1 disposed at a bottom of an overflow brick (not shown in the figures), and a cooling mechanism 2. The two homogenization boxes 1 are respectively located at two sides of a substrate glass 3. The cooling mechanism 2 includes a plurality of cooling units 200. Each of the plurality of cooling units 200 corresponds to one of the two homogenization boxes 1 and includes a first cooling air tube 21, a second cooling air tube 22, and a fixing assembly 23.

The substrate glass 3 refers to a flat glass configured to carry electronic components. For example, the substrate glass 3 may carry electronic components of a display. The substrate glass 3 may be manufactured by an overflow down-draw process or other similar processes.

The overflow brick is a component used in the overflow down-draw process and is configured to carry and guide a molten glass to overflow and flow downward, so as to achieve forming of the substrate glass 3. The overflow brick may be made of high-temperature-resistant and refractory materials to adapt to a high temperature of the molten glass and ensure stability of the overflow process. For example, the overflow brick may be made of high-purity refractory materials such as high-purity alumina or zirconia.

The homogenization box 1 refers to a component configured to uniformly cool the substrate glass 3.

In some embodiments, the two homogenization boxes 1 are respectively located at the two sides of the substrate glass 3 and are configured to cool corresponding positions on the two sides of the substrate glass 3 during the formation of the substrate glass 3. In some embodiments, the two homogenization boxes 1 may be made of silicon carbide materials or other high-thermal-conductivity materials. By manufacturing the homogenization boxes 1 from the silicon carbide materials or other high-thermal-conductivity materials, the homogenization boxes 1 have high thermal conductivity, which facilitates rapid heat exchange with the substrate glass 3, thereby achieving rapid cooling of the substrate glass 3, changing the contraction of the substrate glass 3, and achieving a purpose of thickness adjustment of the substrate glass 3.

The cooling mechanism 2 refers to a component configured to deliver cooling air to the homogenization boxes 1 so as to cool the homogenization boxes 1. In some embodiments, the cooling mechanism 2 includes the plurality of cooling units, each of the plurality of cooling units corresponds to one of the two homogenization boxes 1 and includes the first cooling air tube 21, the second cooling air tube 22, and the fixing assembly 23. As shown in FIG. 1, the cooling mechanism 2 includes six cooling units corresponding to a left homogenization box 1 and six cooling units corresponding to a right homogenization box 1. The cooling units may be uniformly disposed on the corresponding homogenization boxes 1. It should be understood that a count and an arrangement manner of the cooling units may be adjusted according to actual conditions.

The cooling unit refers to a unit component forming the cooling mechanism 2. In some embodiments, the plurality of cooling units 200 may work cooperatively to uniformly blow the cooling air into corresponding homogenization boxes 1.

The first cooling air tube 21 is configured to receive the cooling air from a cooling air generation mechanism and deliver the cooling air to a corresponding second cooling air tube 22. The first cooling air tube 21 may be disposed outside a corresponding homogenization box 1. The first cooling air tube 21 includes an air inlet, which is in communication with the cooling air generation mechanism and is configured to introduce the cooling air.

In some embodiments, the first cooling air tube 21 may be made of a metal material.

By manufacturing the first cooling air tube 21 from a metal material, strength and high-temperature resistance of the first cooling air tube 21 can be improved.

The second cooling air tube 22 is configured to receive the cooling air from a corresponding first cooling air tube 21 and deliver the cooling air to a corresponding homogenization box 1. The second cooling air tube 22 may include an air outlet. The second cooling air tube 22 may be inserted into an interior of the corresponding homogenization box 1, and the air outlet of the second cooling air tube 22 is disposed facing the substrate glass 3. In some embodiments, as shown in FIG. 1, the second cooling air tube 22 may be inserted from a side of the corresponding homogenization box 1 away from the substrate glass 3, and may extend into the interior of the homogenization box 1 but not penetrate through the homogenization box 1 (i.e., not passing through another side of the homogenization box 1 close to the substrate glass 3). In some embodiments, the second cooling air tube 22 may be inserted from the side of the corresponding homogenization box 1 away from the substrate glass 3, and may extend into the interior of the homogenization box 1 and penetrate through the homogenization box 1 (i.e., passing through the another side of the homogenization box 1 close to the substrate glass 3).

The second cooling air tube 22 may be made of a high-temperature-resistant material. In some embodiments, the second cooling air tube 22 may be made of a corundum material. Since the corundum material has excellent high-temperature resistance, the second cooling air tube 22 can withstand high temperatures exceeding 1200° C. In some embodiments, the second cooling air tube 22 may be made of silicon carbide or other high-temperature-resistant ceramic materials. In some embodiments, a distance between the air outlet of the second cooling air tube 22 and the substrate glass 3 is in a range of 5 mm to 10 mm, thereby further improving heat exchange efficiency.

In the embodiments of the present disclosure, by manufacturing the second cooling air tube 22 from a corundum material, the high-temperature strength of the second cooling air tube 22 can be improved, thereby reducing occurrences of ablation or deformation of the second cooling air tube 22 inside the homogenization box 1.

In some embodiments, as shown in FIG. 1, the cooling air device 100 may further include at least one first beam 24 configured to fix corresponding first cooling air tubes 21 of the plurality of cooling units, and the corresponding first cooling air tubes 21 may penetrate through the first beam 24. Specifically, two first beams 24 may be provided, one of which is configured to fix the first cooling air tubes 21 of the cooling units corresponding to the left homogenization box 1, and the other is configured to fix the first cooling air tubes 21 of the cooling units corresponding to the right homogenization box 1.

In the embodiments of the present disclosure, by providing the at least one first beam 24, a supporting effect can be achieved for the first cooling air tubes 21, thereby preventing the first cooling air tubes 21 from being displaced or deformed under high temperatures or under the action of the cooling air, and improving the stability of the first cooling air tubes 21.

In some embodiments, as shown in FIG. 1, a second beam 25 is disposed inside each of the two homogenization boxes 1, and corresponding second cooling air tubes 22 penetrate through the second beam 25.

In the embodiments of the present disclosure, by disposing the second beam 25 inside the corresponding homogenization box 1 and allowing the second cooling air tubes 22 to penetrate through the second beam 25, a supporting effect can be achieved for the second cooling air tubes 22, thereby improving the stability of the second cooling air tubes 22 inside the homogenization box 1.

The fixing assembly 23 refers to a component configured to fix the first cooling air tube 21 and the second cooling air tube 22, and achieve communication between the first cooling air tube 21 and the second cooling air tube 22. By adjusting the fixing assembly 23, fixation and communication between the first cooling air tube 21 and the second cooling air tube 22 can be achieved.

In some embodiments, as shown in FIG. 2, the fixing assembly 23 includes a fixing base 231, a mounting step 232, and a fixing member 233.

The fixing base 231 serves as an installation base for the first cooling air tube 21. The mounting step 232 serves as an installation base for the second cooling air tube 22. In some embodiments, the fixing base 231 and the mounting step 232 may be respectively disposed between the first cooling air tube 21 and the second cooling air tube 22. The fixing base 231 is connected with the first cooling air tube 21, and the mounting step 232 is connected with the second cooling air tube 22. The mounting step 232 is further connected to the fixing base 231, thereby achieving communication between the first cooling air tube 21 and the second cooling air tube 22. In some embodiments, the fixing base 231 may be integrally formed with the first cooling air tube 21, and the mounting step 232 may also be integrally formed with the second cooling air tube 22.

In some embodiments, as shown in FIG. 2, a mounting groove 234 for accommodating the mounting step 232 is provided on the fixing base 231. The mounting step 232 may be inserted into the mounting groove 234 and form a fitted engagement structure with the fixing base 231, so as to achieve a sealing connection between the first cooling air tube 21 and the second cooling air tube 22. In some embodiments, a cross-sectional shape of the mounting groove 234 is adapted to that of the mounting step 232. For example, an outer side of the mounting step 232 may be circular or polygonal, and an inner side of the mounting groove 234 may be correspondingly set to be circular or polygonal, so as to ensure that the mounting groove 234 and the mounting step 232 can be tightly fitted during assembly.

In the embodiments of the present disclosure, by providing the mounting groove 234 on the fixing base 231 for accommodating the mounting step 232, the mounting step 232 can be conveniently and accurately inserted into the mounting groove 234, thereby improving installation stability and sealing reliability between the fixing base 231 and the mounting step 232.

In some embodiments, a sealing member 235 is disposed in the mounting groove 234.

In some embodiments, the sealing member 235 may be made of fluororubber, aluminum silicate, or other high-temperature-resistant materials. For example, the sealing member 235 may be a high-temperature-resistant sealing gasket.

In some embodiments of the present disclosure, by disposing the sealing member 235 in the mounting groove 234, sealing performance between the first cooling air tube 21 and the second cooling air tube 22 can be enhanced, thereby improving connection stability between the first cooling air tube 21 and the second cooling air tube 22, reducing energy loss of the cooling air during transmission, and simplifying maintenance and replacement of the cooling air device 100, thereby improving overall performance and reliability of the cooling air device 100.

The fixing member 233 refers to a component configured to fixedly connect the fixing base 231 to the corresponding homogenization box 1. In some embodiments, the fixing member 233 is configured to fix the first cooling air tube 21 and the second cooling air tube 22 on the homogenization box 1. Specifically, the first cooling air tube 21 and the second cooling air tube 22 may be respectively installed on the fixing base 231 and the mounting step 232, and then the mounting step 232 is mounted in the mounting groove 234 of the fixing base 231 to achieve alignment and communication between the first cooling air tube 21 and the second cooling air tube 22. Subsequently, the second cooling air tube 22 may penetrate through the homogenization box 1 and extend into the interior thereof, and the fixing member 233 may penetrate through one end of the fixing base 231 to fix the fixing base 231 on the homogenization box 1. Accordingly, the first cooling air tube 21 and the second cooling air tube 22 may be fixedly mounted on the homogenization box 1, so that the cooling air can sequentially flow through the first cooling air tube 21 and the second cooling air tube 22 into the interior of the corresponding homogenization box 1.

In some embodiments, the homogenization box 1 may be provided with a threaded structure, and the fixing member 233 may be a fixing bolt. The fixing bolt may penetrate through one end of the fixing base 231 and may be in threaded connection with the homogenization box 1.

In some embodiments, the cooling air may be blown into the first cooling air tube 21 at a preset flow rate and delivered into the interior of the corresponding homogenization box 1 through the second cooling air tube 22. The cooling air exchanges heat with the corresponding homogenization box 1 and the substrate glass 3, thereby reducing the temperature at a corresponding position of the substrate glass 3. As the temperature decreases, viscosity of the substrate glass 3 increases, thereby slowing an influence of a contraction force at the corresponding position of the substrate glass 3, thus achieving the purpose of thickness adjustment of the substrate glass 3.

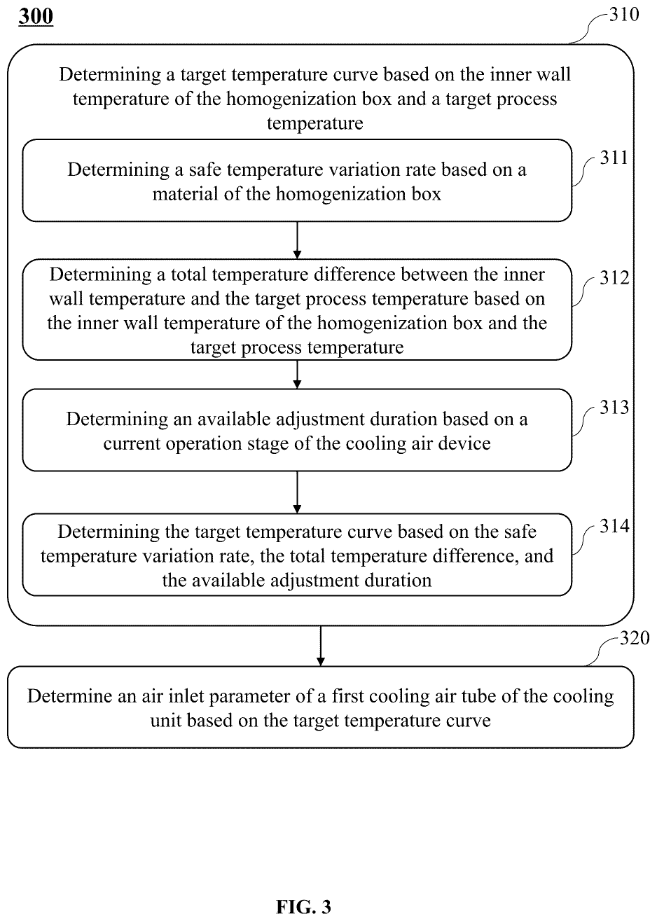

A flow rate of the cooling air refers to a volume of air blown into the first cooling air tube 21 per unit time. The flow rate of the cooling air may be preset in advance according to process requirements. In some embodiments, the flow rate of the cooling air may be adjusted by an adjusting device. More descriptions regarding the adjusting device may be found in FIG. 3 and related descriptions thereof.

In some embodiments, the mounting step 232 may protrude from a surface of the corresponding homogenization box 1 by 5 mm to 15 mm. In some embodiments, the mounting step 232 may protrude from the homogenization box 1 by 10 mm.

In some embodiments of the present disclosure, by allowing the mounting step 232 to protrude from the surface of the homogenization box 1 by 5 mm to 15 mm, the fixation strength of the second cooling air tube 22 on the homogenization box 1 can be enhanced, thereby improving the installation stability of the second cooling air tube 22.

In some embodiments of the present disclosure, by providing the fixing base 231, the mounting step 232, and the fixing member 233, rapid assembly and stable connection of the first cooling air tube 21 and the second cooling air tube 22 can be achieved. At the same time, further fixation of the first cooling air tube 21 and the second cooling air tube 22 on the homogenization box 1 can be achieved, facilitating blowing the cooling air into the corresponding homogenization box 1 through both the first cooling air tube 21 and the second cooling air tube 22, so as to achieve the heat exchange between the cooling air and the corresponding homogenization box 1.

In some embodiments of the present disclosure, the substrate glass 3 is cooled down through the homogenization box 1 rather than directly using the cooling air, and a plurality of cooling units are disposed on each homogenization box 1 to ensure uniformity of cooling performance, avoid overcooling or undercooling in local regions, and further ensure a uniform thickness distribution of the substrate glass 3, thereby improving forming quality as well as accuracy and efficiency of thickness adjustment of the substrate glass 3. The first cooling air tube 21 and the second cooling air tube 22 are in fixed communication with each other through the fixing assembly 23, so that the first cooling air tube 21 and the second cooling air tube 22 may be in sealed communication, thereby ensuring that the cooling air smoothly enters the corresponding homogenization box 1 and performs the heat exchange, so as to achieve accurate adjustment of thicknesses on both sides of the substrate glass 3. Meanwhile, when a size of the homogenization box 1 increases, required air tubes become longer, and installation difficulty is significantly increased. By assembling the first cooling air tube 21 and the second cooling air tube 22 through the fixing assembly 23, the installation difficulty of the first cooling air tube 21 and the second cooling air tube 22 can be effectively reduced, and production and maintenance costs can be decreased.

In some embodiments, the cooling air device 100 further includes an infrared thermal imager and a controller corresponding to each homogenization box 1, and an adjusting device corresponding to each cooling unit 200. Each homogenization box 1 is provided with an independent infrared thermal imager and controller to monitor and control the temperature of the corresponding homogenization box 1, thereby achieving thickness adjustment of the substrate glass 3.

The adjusting device corresponding to each cooling unit 200 is configured to adjust an air inlet parameter of the first cooling air tube of the cooling unit 200, thereby controlling the temperature of the homogenization box 1 and further achieving thickness adjustment of the substrate glass 3. Each cooling unit 200 is provided with an independent adjusting device to independently control the air inlet parameter of the cooling unit 200.

The infrared thermal imager refers to a temperature-measuring device configured to monitor inner wall temperatures of the homogenization box 1. In some embodiments, the infrared thermal imager may be disposed inside the corresponding homogenization box 1 and is configured to monitor the inner wall temperatures of the homogenization box 1. Specifically, the infrared thermal imager may monitor the inner wall temperatures of the homogenization box 1 in a non-contact manner by sensing the intensity of infrared radiation emitted from an inner wall surface of the homogenization box 1. In some embodiments, the plurality of cooling units (or at least a portion thereof) inside the homogenization box 1 may share a single infrared thermal imager. The infrared thermal imager may generate a temperature distribution image, which reflects a temperature distribution condition of an inner wall of the homogenization box 1.

The adjusting device is connected to the first cooling air tube of the cooling unit and is configured to adjust the air inlet parameter of the cooling air blown into the first cooling air tube 21. The air inlet parameter refers to a parameter related to the physical properties of the cooling air. In some embodiments, the air inlet parameter may include at least one of a flow rate, a velocity, and a temperature of the cooling air.

In some embodiments, the adjusting device may include a variable-frequency fan, a regulating valve, an air temperature adjusting device, or the like. The variable-frequency fan may be configured to provide the cooling air and adjust the flow rate and the velocity thereof; the regulating valve may be configured to control a pressure of the cooling air in an air pipeline; and the air temperature adjusting device may be configured to heat or cool the cooling air to adjust its temperature. For example, the air temperature adjusting device may be a heater or a cooler. In some embodiments, an air outlet of the adjusting device may be connected to the first cooling air tube 21.

The controller refers to a device configured to determine and control the air inlet parameter. The controller may be a programmable logic controller (PLC), an industrial computer, an embedded control module, or other control equipment having computing and control functions. In some embodiments, the controller is provided with a memory and a processor.

The processor may be electrically connected to the infrared thermal imager and the adjusting device of each cooling unit, and is configured to receive data from the infrared thermal imager and the adjusting device, and to control the infrared thermal imager and the adjusting device. A plurality of cooling units (or at least a portion thereof) inside the homogenization box 1 may share a single controller. For example, the controller may be electrically connected to each adjusting device corresponding to each cooling unit inside the homogenization box 1, and may control the adjusting device of the cooling unit based on the inner wall temperature acquired by the infrared thermal imager in the homogenization box 1. In some embodiments, the processor is used to execute one or more functions described in the present disclosure. For example, the processor in the controller may execute operations 310-350.

The memory may store data or information generated by other devices, e.g., the inner wall temperatures of the homogenization box 1 monitored by the infrared thermal imager. The memory may also be used configured store data and/or information processed by the processor. For example, the memory may be configured to store the air inlet parameter, etc. The memory may further store a computer command, for example, the computer command may be a coordination command. When the processor reads the computer command stored in the memory, the processor executes methods disclosed in the present disclosure. In some embodiments, for each cooling unit, the controller may determine the air inlet parameter of the first cooling air tube 21 of the cooling unit through a process 300 shown in FIG. 3. In some embodiments, the process 300 is executed by the processor in the controller.

In 310, a target temperature curve is determined based on the inner wall temperature of the homogenization box 1 and a target process temperature.

The target process temperature refers to an ideal temperature value of the inner wall temperature of the homogenization box 1 during substrate glass forming, so as to meet process requirements. In some embodiments, the target process temperature may be preset by a technician in advance according to the process requirements, so that the inner wall temperature of the homogenization box 1 is maintained within an appropriate temperature range, thereby preventing its temperature from being excessively high or low, which may cause an abnormal outlet temperature of the cooling air and affect the stability of the heat exchange and cooling performance.

The target temperature curve refers to an ideal path in which the inner wall temperature of the homogenization box 1 varies with time and gradually transitions to the target process temperature. The target temperature curve may include the inner wall temperatures of the homogenization box 1 at a plurality of preset future time points. The target temperature curve characterizes that, within a preset future period, the tube wall temperature of the second cooling air tube 22 continuously and smoothly changes in the process of transitioning to the target process temperature, thereby avoiding deformation of the homogenization box 1 caused by a sudden temperature change.

In some embodiments, the target temperature curve may be determined in the controller in various ways. For example, the controller may determine the target temperature curve based on the inner wall temperature of the homogenization box 1 and the target process temperature by querying a first database. The first database may include historical inner wall temperatures of the homogenization box 1 and corresponding historical temperature variation curves. For example, a plurality of historical adjustment records of the cooling air device 100 may be analyzed to determine a first historical inner wall temperature of the homogenization box 1 before each air inlet parameter adjustment, a second historical inner wall temperature after the air inlet parameter adjustment, and a historical temperature variation curve during the air inlet parameter adjustment. In some embodiments, a target historical adjustment record may be screened from the plurality of historical adjustment records, in which a corresponding historical temperature variation curve varies smoothly and does not exceed a safe threshold. The first historical inner wall temperature, the second historical inner wall temperature, and the historical temperature variation curve corresponding to the target historical adjustment record may be stored in the first database. For each target historical adjustment record in the first database, the controller may determine a first difference between the first historical inner wall temperature of the target historical adjustment record and the inner wall 1 temperature of the homogenization box 1, and a second difference between the second historical inner wall temperature of the target historical adjustment record and the target process temperature. A total difference may be determined based on a sum or a weighted sum of the first difference and the second difference. In some embodiments, the controller may select a target historical adjustment record with a minimum total difference and use a historical temperature variation curve corresponding to the target historical adjustment record as the target temperature curve.

In some embodiments, the target temperature curve may be determined through operations 311-314.

In 311, a safe temperature variation rate is determined based on a material of the homogenization box 1.

The safe temperature variation rate refers to a temperature variation rate allowable for the material of the homogenization box 1. The safe temperature variation rate may ensure that the homogenization box 1 does not undergo structural damage, such as cracking, during a heating or cooling process. For example, the safe temperature variation rate may include a maximum heating rate or a maximum cooling rate.

In some embodiments, the safe temperature variation rate may be preset based on thermodynamic performance parameters (e.g., a thermal expansion coefficient, a thermal conductivity, and a thermal shock resistance) of the material of the homogenization box 1. In some embodiments, the safe temperature variation rate of the homogenization box 1 may be determined by querying a material-safe temperature variation rate comparison table.

In 312, a total temperature difference between the inner wall temperature and the target process temperature is determined based on the inner wall temperature of the homogenization box 1 and the target process temperature.

The total temperature difference refers to a difference between the inner wall temperature of the homogenization box 1 and the target process temperature.

In 313, an available adjustment duration is determined based on a current operation stage of the cooling air device 100.

The current operation stage refers to an operation stage of the cooling air device 100 in a current time period. In some embodiments, the current operation stage may include one of a startup stage, a normal operation stage, a process adjustment stage, and a shutdown stage. The startup stage refers to a stage in which the cooling air device 100 starts heating from a cold state or a shutdown state until reaching a target operating temperature. The normal operation stage refers to a stage in which the cooling air device 100 operates with an operating temperature maintained within a preset range near the target operating temperature after the operating temperature reaches the target operating temperature. The process adjustment stage refers to a stage in which the air inlet parameter of the first cooling air tube 21 is adjusted due to a change in a thickness, or a process of the substrate glass 3. The shutdown stage refers to a stage in which the cooling air device 100 stops operating and is gradually cooled to a safe temperature. The target operating temperature refers to an ideal temperature maintained by the cooling air device 100 during stable operation to ensure structural stability and safety of the device. The target operating temperature may be preset by the technician according to operating requirements of the cooling air device 100. A preset range near the target operating temperature and the safe temperature may be preset by the technician according to process requirements. The target operating temperature and the target process temperature may be identical or different.

The available adjustment duration refers to a time range allowed in the current operation stage for completing a temperature adjustment or maintaining temperature stability. In some embodiments, the available adjustment duration may vary among different operation stages. Merely by way of example, in the process adjustment stage, the available adjustment duration may be used to define a time budget for completing one adjustment of the inner wall temperature. In the startup stage or the shutdown stage, the available adjustment duration may be used to define an allowable time range for a heating or cooling process. In the normal operation stage, the available adjustment duration may be used to define a time period during which an operating temperature of the cooling air device 100 is maintained within a preset range near the target operating temperature, so as to determine whether the cooling air device 100 is in a stable operation state. For example, in the startup stage, when the cooling air device 100 is heated to the target operating temperature, the available adjustment duration may be limited to 10 minutes (i.e., the heating needs to be completed within 10 minutes). In the shutdown stage, when the cooling air device 100 is cooled to the safe temperature, the available adjustment duration may be limited to 15 minutes (i.e., the cooling needs to be completed within 15 minutes).

In some embodiments, the controller may determine the available adjustment duration by querying a comparison table based on the current operation stage of the cooling air device 100. The comparison table may include correspondences between a plurality of operation stages of the cooling air device 100 and available adjustment durations. The comparison table may be constructed in advance based on historical data or prior knowledge.

In 314, the target temperature curve is determined based on the safe temperature variation rate, the total temperature difference, and the available adjustment duration.

In some embodiments, the controller may determine the target temperature curve by adopting an S-shaped curve planning algorithm, in which the target temperature curve enables the inner wall temperature of the homogenization box 1 to transition to the target process temperature within the available adjustment duration, while the temperature variation rate does not exceed the safe temperature variation rate. In some embodiments, the controller may generate a plurality of temperature variation curves satisfying the above conditions and select a smoothest temperature variation curve as the target temperature curve.

In some embodiments of the present disclosure, by presetting the safe temperature variation rate based on the material of the homogenization box 1 and determining the target temperature curve in combination with the total temperature difference and the available adjustment duration, a variation trajectory of the inner wall temperature of the homogenization box 1 satisfies process efficiency requirements while ensuring that the cooling air device 100 operates within a safe temperature range. Meanwhile, by adopting the S-shaped curve planning algorithm to determine the target temperature curve, a variation process of the inner wall temperature of the homogenization box 1 becomes continuous and step-free, thereby effectively avoiding damage to the homogenization box 1 caused by thermal shock, improving stability and precision of the temperature control process, and preventing an excessively rapid temperature change caused by improper manual operations.

In 320, the air inlet parameter of the first cooling air tube 21 of the cooling unit is determined based on the target temperature curve.

In some embodiments, the controller may determine the air inlet parameter based on the target temperature curve by querying a second database. The second database may include correspondences between a plurality of temperature variation curves and a plurality of air inlet parameters, in which each temperature variation curve is smooth and has a temperature variation rate not exceeding the safe temperature variation rate. The controller may obtain the adjusted air inlet parameter and the historical temperature variation curve corresponding to the target historical adjustment record described above to construct the second database. The processor of the controller may query, in the second database, a historical temperature variation curve having a highest similarity to the target temperature curve and use a corresponding air inlet parameter as the air inlet parameter of the first cooling air tube 21 of the cooling unit.

In some embodiments of the present disclosure, dynamic adjustment of the air inlet parameter of the first cooling air tube may be achieved based on the infrared thermal imager, the adjusting device, and the controller, so that the inner wall temperature of the homogenization box 1 transitions to the target process temperature in a smooth manner. Meanwhile, thermal stress caused by uneven thermal expansion and contraction may be significantly reduced, deformation and aging of the homogenization box 1 may be fundamentally delayed, a service life of the cooling air device 100 may be extended, and safety and reliability of the cooling air device 100 during operation may be improved.

In some embodiments, the controller is configured to obtain, for each of a plurality of second cooling air tubes 22 of the plurality of cooling units, a deformation parameter and an aging coefficient of the second cooling air tube 22, and to determine a cooling efficiency coefficient of the second cooling air tube 22 based on the deformation parameter and the aging coefficient. Further, the controller is configured to determine a response matrix set based on cooling efficiency coefficients of the plurality of second cooling air tubes 22 and an air inlet test set, and to determine a coordination command based on the response matrix set, the coordination command being used to control a flow rate of at least a portion of the plurality of second cooling air tubes 22.

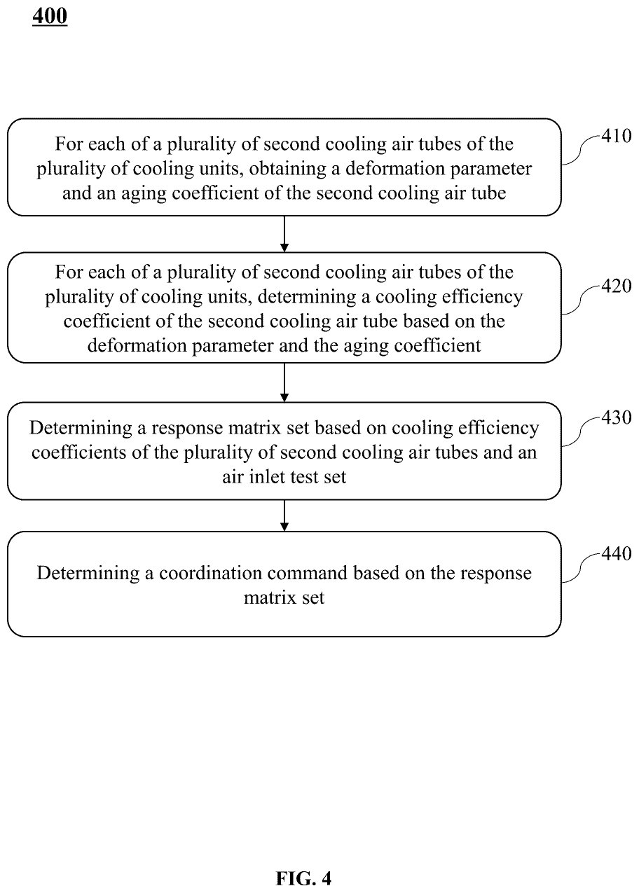

FIG. 4 is a flowchart illustrating an exemplary process for determining a coordination command according to some embodiments of the present disclosure.

In 410, for each of a plurality of second cooling air tubes 22 of a plurality of cooling units, a deformation parameter and an aging coefficient of the second cooling air tube 22 are obtained.

The deformation parameter refers to a parameter related to a degree of shape variation of the second cooling air tube 22.

In some embodiments, the deformation parameter may include an angle deviation Y′ of an air outlet of the second cooling air tube 22 and a position offset distance d of an air outlet center, so as to reflect an offset of the air outlet relative to an initial design state after long-term operation. The position offset distance d refers to a linear distance between a position of the air outlet of the second cooling air tube 22 at a current time and a theoretical position, and the angle deviation Y′ refers to an included angle between an actual blowing direction of the second cooling air tube 22 and a theoretical direction. The theoretical position refers to a position of the air outlet of the second cooling air tube 22 in an initial design state. The theoretical direction refers to a blowing direction of the second cooling air tube 22 in the initial design state, which may be perpendicular to a surface of the substrate glass 3. The theoretical position and the theoretical direction may be preset by the technician according to process requirements.

In some embodiments, for each second cooling air tube 22, the controller may determine a temperature distribution at the air outlet of the second cooling air tube 22 through an infrared thermal imager, extract a temperature distribution feature of the temperature distribution, and determine the deformation parameter of the second cooling air tube 22 based on the temperature distribution feature.

The temperature distribution refers to a temperature distribution in a preset region near the air outlet of the second cooling air tube 22 and is used to reflect temperature variations within the region. The temperature distribution may be presented in an image form. For example, the temperature distribution may be a temperature distribution image.

In some embodiments, the infrared thermal imager may monitor temperatures in the preset region near the air outlet of the second cooling air tube 22 and generate the temperature distribution image.

The temperature distribution feature refers to a feature describing the temperature distribution, which are related to deformation of the air outlet of the second cooling air tube 22. The temperature distribution feature may include symmetry of the temperature distribution, a shape feature of isotherms, a center position of a high-temperature region, etc. The symmetry of the temperature distribution is used to reflect whether the air outlet of the second cooling air tube 22 deviates from the theoretical direction. The shape feature of the isotherms is used to reflect whether a shape of the air outlet of the second cooling air tube 22 is distorted or has an irregular edge. The center position of the high-temperature region is used to reflect whether the air outlet center of the second cooling air tube 22 is positionally offset.

In some embodiments, the controller may analyze the temperature distribution image acquired by the infrared thermal imager through an image processing algorithm to extract the temperature distribution feature in the temperature distribution image. Specifically, the image processing algorithm may identify quantitative indicators such as the symmetry of the temperature distribution, the shape feature of the isotherms, and the center position of the high-temperature region according to a spatial distribution of pixel temperature values in the temperature distribution image. For example, when the second cooling air tube 22 is not deformed, the temperature distribution is approximately symmetrical, and the isotherms are relatively circular and smooth; whereas when the second cooling air tube 22 is bent or displaced, the isotherms become skewed or irregularly deformed, and the center position of the high-temperature region offsets toward a deformation direction.

In some embodiments, the controller may match the extracted temperature distribution feature with a plurality of sample temperature distribution feature in a standard feature library and take a deformation parameter corresponding to the matched sample temperature distribution feature as the deformation parameter of the second cooling air tube 22. The standard feature library includes correspondences between a plurality of sample temperature distribution features and deformation parameters. The standard feature library may be constructed in advance based on historical data or prior knowledge.

In some embodiments of the present disclosure, by obtaining the temperature distribution in the region near the air outlet of the second cooling air tube 22 and determining the deformation parameter through extracting the temperature distribution feature using the image processing algorithm, non-contact monitoring of deformation of the second cooling air tube 22 in a high-temperature sealed environment in the homogenization box 1 may be achieved. As a result, stable and accurate monitoring of the deformation of the second cooling air tube 22 is realized, effectively solving a technical problem that the deformation of the air tube cannot be directly measured in a high-temperature environment.

The aging coefficient refers to a coefficient quantifying a degree of attenuation of cooling efficiency of the second cooling air tube 22. The aging coefficient may have a value range of 0 to 1 and is used to indicate a proportion of attenuation of the cooling efficiency of the second cooling air tube 22 relative to the initial design state. For example, a value of 1 represents that the cooling efficiency of the second cooling air tube 22 remains at an initial level, and a value of 0.8 represents that the cooling efficiency has decayed to 80% of the initial level.

In some embodiments, the cooling air device 100 further includes a flow sensor and a pressure sensor corresponding to each second cooling air tube 22 of each cooling unit.

For each second cooling air tube 22, the controller may determine flow rates and pressure drops of cooling air flowing through the second cooling air tube 22 at a plurality of time points by the flow sensor and the pressure sensor corresponding to the second cooling air tube 22.

For example, the flow sensor may measure a flow velocity of the cooling air, and a flow rate of the cooling air flowing through the second cooling air tube 22 may be determined based on a product of the flow velocity and a cross-sectional area of the second cooling air tube 22. The flow sensor may be disposed at any position of the second cooling air tube 22, such as the air inlet, the air outlet, etc.

As another example, the pressure sensor may be a differential pressure sensor. A first pressure tapping port of the differential pressure sensor may be disposed at the air inlet of the second cooling air tube 22 and used for measuring an inlet pressure, and a second pressure tapping port may be disposed at the air outlet of the second cooling air tube 22 and used for measuring an outlet pressure. The pressure drop of the cooling air flowing through the second cooling air tube 22 may be determined based on a difference between the inlet pressure and the outlet pressure.

The controller may determine the aging coefficient of the second cooling air tube 22 based on the flow rates and the pressure drops at a plurality of time points. Merely by way of example, the controller may perform quadratic polynomial fitting on the flow rates and the pressure drops of the cooling air flowing through the second cooling air tube 22 at the plurality of time points and determine an actual flow resistance R of the second cooling air tube 22 using an equivalent flow resistance manner. In some embodiments, the aging coefficient may be determined based on the actual flow resistance R according to the following formula (1):

$$k = ( R - {R}_{0} ) / {R}_{0} \qquad ( 1 )$$

where k represents the aging coefficient of the second cooling air tube 22, R₀ represents an initial flow resistance of the second cooling air tube 22 in the initial design state, and R represents an actual flow resistance in a current time period. The flow resistance refers to a parameter related to the airflow resistance when the cooling air flows through the second cooling air tube 22. The initial flow resistance R₀ may be obtained by performing a baseline test on the second cooling air tube 22 before the cooling air device 100 is put into operation, so as to ensure that the initial flow resistance R₀ can accurately reflect initial performance of the second cooling air tube 22.

In some embodiments of the present disclosure, by determining the flow rates and the pressure drops of the cooling air flowing through the second cooling air tube 22 at the plurality of time points through the flow sensor and the pressure sensor corresponding to the second cooling air tube 22 of each cooling unit, a quantitative evaluation of the aging attenuation of the second cooling air tube 22 can be performed during normal operation of the cooling air device 100 to reflect an aging trend of the second cooling air tube 22. Meanwhile, by analyzing the flow rates and the pressure drops at the plurality of time points, faults such as blockage and deformation inside the second cooling air tube 22 can be effectively diagnosed, thereby enabling performance monitoring and predictive maintenance of the cooling air device 100 and improving operational safety of the cooling air device 100.

In 420, for each of the plurality of second cooling air tubes of the plurality of cooling units, a cooling efficiency coefficient of the second cooling air tube is determined based on the deformation parameter and the aging coefficient.

The cooling efficiency coefficient refers to a coefficient used to characterize an actual cooling capacity of the second cooling air tube 22. A larger cooling efficiency coefficient indicates a higher cooling capacity of the second cooling air tube 22.

In some embodiments, for each of the plurality of second cooling air tubes of the plurality of cooling units, the controller may determine the cooling efficiency coefficient of the second cooling air tube 22 based on the deformation parameter and the aging coefficient. Merely by way of example, the cooling efficiency coefficient may be determined according to the following formula (2):

$$η = ( 1 - \frac{d}{{D}_{offset}} ) \cdot cos ( ψ ) \cdot \frac{1}{\sqrt{1 + k}} \qquad ( 2 )$$

where η represents the cooling efficiency coefficient, which ranges from 0 to 1. The closer η is to 1, the closer the cooling performance of the air tube is to its design initial state. d represents the position offset distance of the air outlet center of the second cooling air tube 22. D_{offset} represents a maximum allowable position offset distance, which may be preset according to process requirements. ψ represents the angle deviation of the air outlet of the second cooling air tube 22. k represents the aging coefficient of the second cooling air tube 22.

In 430, a response matrix set is determined based on cooling efficiency coefficients of the plurality of second cooling air tubes and an air inlet test set.

The air inlet test set refers to a test data set composed of a plurality of air inlet parameters. The air inlet test set may include a plurality of preset or historically collected air inlet parameters, and each air inlet parameter includes at least one of a flow rate, a velocity, and a temperature of the cooling air for each of the second cooling air tubes 22. The air inlet parameters of different second cooling air tubes may be the same or different. The air inlet test set may be pre-constructed based on historical data or prior knowledge.

The response matrix set includes a plurality of response matrices corresponding to a plurality of air inlet parameters. Each response matrix corresponds to one air inlet parameter and is used to characterize a cooling intensity distribution generated by a plurality of second cooling air tubes 22 on the substrate glass 3 under the corresponding air inlet parameter. The cooling intensity distribution refers to a distribution of cooling intensities varying with positions on the surface of the substrate glass 3 formed by the plurality of second cooling air tubes 22. For example, each element in the response matrix corresponds to a preset position on the surface of the substrate glass 3, and a value of the element reflects a cooling intensity of the plurality of second cooling air tubes 22 at the preset position. In some embodiments, for each second cooling air tube 22, the controller may predict an initial cooling intensity at the preset position on the surface of the substrate glass 3 based on the air inlet parameter and the cooling efficiency coefficient of the second cooling air tube 22. In some embodiments, the controller may determine an overall cooling intensity at the preset position based on initial cooling intensities of the plurality of second cooling air tubes 22 at the preset position.

In some embodiments, the controller may determine a response matrix corresponding to each air inlet parameter in the air inlet test set through a first prediction model based on cooling efficiency coefficients of the plurality of second cooling air tubes and the air inlet test set, and combine a plurality of response matrices to form the response matrix set. The first prediction model may be a machine learning model. For example, the first prediction model may be a neural network (NN). In some embodiments, an input of the first prediction model may include an air inlet parameter in the air inlet test set and the cooling efficiency coefficient of each of the plurality of second cooling air tubes 22, and an output of the first prediction model may be a response matrix corresponding to the air inlet parameter.

Training samples of the first prediction model may include sample air inlet parameters and sample cooling efficiency coefficients. Training labels corresponding to the training samples may be sample cooling intensity distributions. The sample air inlet parameters, the sample cooling efficiency coefficients, and the sample cooling intensity distributions are similar to the air inlet parameter, the cooling efficiency coefficient, and cooling intensity distribution described above, and thus are not described in detail herein. The training samples may be determined based on historical data, and the training labels corresponding to the training samples may be obtained by collecting temperature variation data at different positions on the surface of the substrate glass 3 using the infrared thermal imager and determining temperature drop rates.

In some embodiments, the first prediction model may be trained and obtained through a plurality of training samples with training labels. The processor may perform the following training process to obtain the first prediction model. The training process includes: acquiring a plurality of training samples with training labels to form a training sample set, and performing multiple iterations based on the training sample set. At least one iteration includes: selecting one or more training samples from the training sample set, inputting the one or more training samples into an initial first prediction model to obtain network outputs corresponding to the one or more training samples; substituting the network outputs and training labels corresponding to the one or more training samples into a predefined loss function to calculate a value of the loss function; and iteratively updating model parameters of the initial first prediction model based on the value of the loss function until an iteration termination condition is satisfied, thereby obtaining a trained first prediction model. The model parameters of the initial first prediction model may be updated in various ways, for example, based on a gradient descent manner. The iteration termination condition may include convergence of the loss function or a count of iterations reaching an iteration threshold.

In 440, a coordination command is determined based on the response matrix set.

The coordination command refers to a command for controlling a plurality of second cooling air tubes 22 to operate collaboratively. The coordination command may be used to control a flow rate of cooling air in at least a portion of the plurality of second cooling air tubes 22. The coordination command may include flow rate command values of the plurality of second cooling air tubes 22. Each flow rate command value may be used to indicate the flow rate of the cooling air to be allocated to each of the second cooling air tubes 22. In some embodiments, the controller may send the coordination command to the adjusting device to control the air inlet parameter at the air inlet of the corresponding first cooling air tube 21, so that each second cooling air tube 22 corresponding to each first cooling air tube 21 is allocated a corresponding flow rate of the cooling air.

In some embodiments, the controller may determine the coordination command based on the response matrix set. Specifically, the processor may construct a vector to be matched according to the air inlet parameter of the cooling air device 100 under a current operating state; construct reference vectors based on the air inlet parameters corresponding to the response matrix set; determine a similarity between the vector to be matched and each reference vector; select a reference vector with the highest similarity and determine a response matrix corresponding to the reference vector; extract a cooling intensity corresponding to a target position from the cooling intensity distribution in the response matrix and construct a cooling intensity vector; and construct an optimization model based on the cooling intensity vector and solve the optimization model using a numerical optimization algorithm to obtain the flow rate command values of the second cooling air tubes 22, thereby determining the coordination command. The target position may be a position on the surface of the substrate glass 3 where a temperature anomaly or a thickness deviation occurs and may be preset by the technician according to process requirements. The optimization model refers to a mathematical model in that takes the minimization of an error between a target cooling effect and a cooling effect vector as an optimization objective.

In some embodiments, the controller may construct the optimization model by taking flow rate command values of the second cooling air tubes 22 as variables, designating the minimization of an error between the cooling effect vector and a target cooling value as an objective function, and incorporating physical constraint conditions such as upper and lower limits of the flow rate. The target cooling value refers to a desired cooling effect or temperature at the target position and may be preset by the technician according to process requirements.

In some embodiments of the present disclosure, by configuring the controller to acquire deformation parameters and the aging coefficients of the plurality of second cooling air tubes 22 and to determine the cooling efficiency coefficients of the second cooling air tubes 22, and further to determine the response matrix set and the coordination command, deviations in cooling performance caused by deformation, aging, and other factors of the second cooling air tubes 22 can be actively corrected based on the coordination command. As a result, the second cooling air tubes 22 can maintain high-precision cooling performance during long-term operation of the cooling air device 100, thereby maintaining consistency and stability of the thickness of the substrate glass 3 and significantly improving operational reliability and the product yield of the cooling air device 100.

The embodiments of the present disclosure provide a method for using the cooling air device for substrate glass forming by an overflow process, including the following operations.

In some embodiments, the technician may mount the two homogenization boxes 1 on two sides of the substrate glass 3 according to design requirements to ensure that positions of the two homogenization boxes 1 relative to the corresponding sides of the substrate glass 3 are accurate and secure. Subsequently, the first cooling air tube 21 and the second cooling air tube 22 may be placed in communication and fixed through the fixing assembly 23 to assemble the cooling air device 100.

In some embodiments, after the cooling air device 100 is assembled, the cooling air may be blown into the air inlet of the first cooling air tube 21. As the cooling air flows through the first cooling air tube 21, a certain amount of heat may be absorbed, thereby reducing the temperature of the first cooling air tube 21. Because the first cooling air tube 21 and the second cooling air tube 22 are placed in communication and fixed through the fixing assembly 23, the cooling air may flow along the first cooling air tube 21 into the second cooling air tube 22, then continue to flow and accelerate, and finally may be blown from the air outlet of the second cooling air tube 22 toward the interior of the homogenization box 1. The cooling air may perform the heat exchange with the homogenization box 1 and the substrate glass 3 to carry away the heat of the substrate glass 3, thereby reducing the temperature at a corresponding position of the substrate glass 3.

As the temperature of the substrate glass 3 decreases, the fluidity of the substrate glass 3 is reduced. During the substrate glass forming by the overflow process, the fluidity of the substrate glass 3 has a direct effect on the thickness of the substrate glass 3. Therefore, by adjusting parameters such as the flow rate, the velocity, and the temperature of the cooling air, the fluidity of the substrate glass 3 can be precisely controlled, thereby achieving the thickness adjustment of the substrate glass 3.

In some embodiments of the present disclosure, by precisely adjusting parameters such as the flow rate, the velocity, and the temperature of the cooling air, the temperature and fluidity of the substrate glass 3 can be maintained within a controllable range, thereby achieving precise thickness adjustment of the substrate glass 3 and improving product quality stability and consistency. Because the cooling air device 100 enables precise control of the thickness of the substrate glass 3, the defect rate caused by thickness non-uniformity can be reduced, thereby lowering production costs. Meanwhile, the cooling air device 100 is simple and convenient to operate, enabling technicians to quickly adjust the thickness of the substrate glass 3, thereby improving production efficiency. By performing the heat exchange using the cooling air, the cooling air device 100 can effectively reduce the temperature of the substrate glass 3 and decrease energy consumption and environmental pollution.

The basic concepts have been described above. Obviously, to a person skilled in the art, the above detailed disclosure is merely an example and does not constitute a limitation to the present disclosure. Although not explicitly stated herein, a person skilled in the art may make various modifications, improvements, and amendments to the present disclosure. Such modifications, improvements, and amendments are suggested in the present disclosure, so they still fall within the spirit and scope of the exemplary embodiments of the present disclosure.

Meanwhile, the present disclosure uses specific words to describe the embodiments of the present disclosure. For example, “one embodiment,” “an embodiment,” and/or “some embodiments” mean a certain feature, structure, or characteristic related to at least one embodiment of the present disclosure. Therefore, it should be emphasized and noted that “an embodiment” or “one embodiment” or “an alternative embodiment” mentioned two or more times in different locations in the present disclosure does not necessarily refer to the same embodiment. In addition, certain features, structures, or characteristics in one or more embodiments of the present disclosure may be appropriately combined.

In addition, unless explicitly stated in the claims, the order of processing elements and sequences, the use of numbers and letters, or the use of other names in the present disclosure are not used to limit the order of the processes and methods of the present disclosure. Although the above disclosure discusses some embodiments of the invention currently considered useful through various examples, it should be understood that such details are for illustrative purposes only. The appended claims are not limited to the disclosed embodiments. Instead, the claims are intended to cover all modifications and equivalent combinations that conform to the substance and scope of the embodiments of the present disclosure. For example, although the implementation of various components described above may be embodied in a hardware device, it may also be implemented as a software only solution, e.g., an installation on an existing server or mobile device.

Similarly, it should be noted that, in order to simplify the expression disclosed in the present disclosure and thereby facilitate understanding of one or more embodiments of the invention, various features are sometimes grouped into one embodiment, drawing, or description thereof in the foregoing description of the embodiments of the present disclosure. However, this disclosure method does not mean that the object of the present disclosure requires more features than those mentioned in the claims. Rather, claimed subject matter may lie in less than all features of a single foregoing disclosed embodiment.

Some embodiments use numbers describing the quantity of components or properties. It should be understood that such numbers used to describe embodiments are modified by the modifiers “approximately,” “about,” or “substantially” in some examples. Unless otherwise stated, “approximately,” “about,” or “substantially” indicates that the stated number allows a variation of +20%. Accordingly, in some embodiments, the numerical parameters used in the specification and claims are approximations, which may vary depending on the desired characteristics of individual embodiments. In some embodiments, numerical parameters should consider the specified number of significant digits and apply the method of general digit retention. Although the numerical ranges and parameters used to confirm the breadth of their scope in some embodiments of the present disclosure are approximations, such numerical values are set as precisely as possible within the feasible range in specific embodiments.

Each patent, patent application, patent application publication, and other material, such as articles, books, specifications, publications, documents, etc., cited in the present disclosure is hereby incorporated by reference in its entirety. Excluded are application history documents that are inconsistent with or conflict with the content of the present disclosure. Also excluded are documents that limit the broadest scope of the claims of the present disclosure (whether currently or subsequently appended to the present disclosure). It should be noted that if the description, definition, and/or use of terminology in the ancillary materials of the present disclosure is inconsistent with or conflicts with the description, definition, and/or use of terminology in the present disclosure, the description, definition, and/or use of terminology in the present disclosure shall prevail.

Finally, it should be understood that the embodiments described in the present disclosure are only used to illustrate the principles of the embodiments of the present disclosure. Other variations may also fall within the scope of the present disclosure. Therefore, by way of example and not limitation, alternative configurations of the embodiments of the present disclosure may be considered consistent with the teachings of the present disclosure. Accordingly, the embodiments of the present disclosure are not limited to the embodiments explicitly introduced and described in the present disclosure.

What is claimed is:

1. A cooling air device for substrate glass forming by an overflow process, comprising: two homogenization boxes disposed at a bottom of an overflow brick, and a cooling mechanism, wherein:
the two homogenization boxes are respectively located at two sides of a substrate glass;
the cooling mechanism comprises a plurality of cooling units, which are respectively disposed on the two homogenization boxes, each of the plurality of cooling units comprises a first cooling air tube, a second cooling air tube, and a fixing assembly;
the first cooling air tube is disposed outside a corresponding homogenization box, and an air inlet of the first cooling air tube is configured to be in communication with a cooling air generation mechanism;
the second cooling air tube is inserted into an interior of a corresponding homogenization box, an air outlet of the second cooling air tube is disposed facing the substrate glass, and the second cooling air tube is made of a high-temperature-resistant material; and
the first cooling air tube and the second cooling air tube are in communication with each other through the fixing assembly.

2. The cooling air device of claim 1, wherein the fixing assembly comprises a fixing base, a mounting step, and a fixing member;
the fixing base and the mounting step are disposed between the first cooling air tube and the second cooling air tube;
the fixing base is connected with the first cooling air tube, and the mounting step is connected with the second cooling air tube; and
the fixing member penetrates through one end of the fixing base and is fixed on the corresponding homogenization box, and the fixing member is configured to achieve fixed communication between the first cooling air tube and the second cooling air tube.

3. The cooling air device of claim 2, wherein the mounting step protrudes from a surface of the corresponding homogenization box by 5 mm to 15 mm.

4. The cooling air device of claim 2, wherein the fixing base is provided with a mounting groove for accommodating the mounting step.

5. The cooling air device of claim 4, wherein a sealing member is disposed in the mounting groove.

6. The cooling air device of claim 1, wherein the first cooling air tube is made of a metal material.

7. The cooling air device of claim 1, wherein the second cooling air tube is made of a corundum material.

8. The cooling air device of claim 1, wherein the cooling air device further comprises at least one first beam configured to fix corresponding first cooling air tubes.

9. The cooling air device of claim 1, wherein a second beam is disposed inside each of the two homogenization boxes, and corresponding second cooling air tubes penetrate through the second beam.

10. The cooling air device of claim 1, wherein the cooling air device further comprises an infrared thermal imager and a controller corresponding to each of the two homogenization boxes, and an adjusting device corresponding to each of the plurality of cooling units, wherein:
the infrared thermal imager is disposed inside a corresponding homogenization box and is configured to monitor an inner wall temperature of the homogenization box;
the adjusting device is connected to a first cooling air tube of a corresponding cooling unit and is configured to adjust an air inlet parameter of the first cooling air tube, the air inlet parameter including at least one of a flow rate, a velocity, and a temperature of cooling air; and
for each of the plurality of cooling units, the controller is configured to:
determine a target temperature curve based on the inner wall temperature of the homogenization box and a target process temperature; and
determine an air inlet parameter of a first cooling air tube of the cooling unit based on the target temperature curve.

11. The cooling air device of claim 10, wherein determining the target temperature curve based on the inner wall temperature of the homogenization box and the target process temperature comprises:
determining a safe temperature variation rate based on a material of the homogenization box;
determining a total temperature difference between the inner wall temperature and the target process temperature based on the inner wall temperature of the homogenization box and the target process temperature;
determining an available adjustment duration based on a current operation stage of the cooling air device, the current operation stage comprising one of a startup stage, a normal operation stage, a process adjustment stage, and a shutdown stage; and
determining the target temperature curve based on the safe temperature variation rate, the total temperature difference, and the available adjustment duration.

12. The cooling air device of claim 10, wherein the controller is further configured to:
for each of a plurality of second cooling air tubes of the plurality of cooling units,
obtain a deformation parameter and an aging coefficient of the second cooling air tube; and
determine a cooling efficiency coefficient of the second cooling air tube based on the deformation parameter and the aging coefficient;
determine a response matrix set based on cooling efficiency coefficients of the plurality of second cooling air tubes and an air inlet test set; and
determine a coordination command based on the response matrix set, the coordination command being used to control a flow rate of at least a portion of the plurality of second cooling air tubes.

13. The cooling air device of claim 12, wherein the deformation parameter of each of the plurality of second cooling air tubes of the plurality of cooling units is obtained by:
determining a temperature distribution at the air outlet of the second cooling air tube through the infrared thermal imager;
extracting a temperature distribution feature of the temperature distribution; and
determining the deformation parameter of the second cooling air tube based on the temperature distribution feature.

14. The cooling air device of claim 13, wherein the cooling air device further comprises a flow sensor and a pressure sensor corresponding to each of the plurality of second cooling air tubes of the plurality of cooling units, wherein the aging coefficient of the second cooling air tube is obtained by:
determining flow rates and pressure drops of cooling air flowing through the second cooling air tube at a plurality of time points by the flow sensor and the pressure sensor corresponding to the second cooling air tube; and
determining the aging coefficient of the second cooling air tube based on the flow rates and the pressure drops at the plurality of time points.

15. A method for using the cooling air device for substrate glass forming by an overflow process according to claim 1, wherein the method comprises:
for each of the plurality of cooling units,
communicating and fixing the first cooling air tube and the second cooling air tube of the cooling unit based on the fixing assembly of the cooling unit; and
blowing cooling air into the first cooling air tube, and blowing the cooling air into the interior of the corresponding homogenization box of the cooling unit through the air outlet of the second cooling air tube, so that heat exchange is performed among the cooling air, the corresponding homogenization box, and the substrate glass to reduce a temperature at a corresponding position of the substrate glass to achieve thickness adjustment of the substrate glass.
